(19) United States
(12) Patent Application Publication
(10) Pub. No.: US 2012/0106964 A1
(43) Pub. Date: May 3, 2012

(54) Novel RFoG CPE device offering enhanced services overlay

(76) Inventor: Oleh Sniezko, Highlands Ranch, CO (US)

(21) Appl. No.: 13/200,192

(22) Filed: Sep. 20, 2011

Related U.S. Application Data
(60) Provisional application No. 61/403,667, filed on Sep. 20, 2010.

(51) Int. Cl. H04J 14/00

(52) U.S. Cl. 398/67

(57) ABSTRACT

A method includes: receiving a downstream optical signal propagating away from a head end; dividing the downstream optical signal into a downstream high portion and a downstream low portion; diplexing the downstream low portion with an upstream low portion; combining the upstream low portion and an upstream high portion; and transmitting the combined upstream portions as an upstream optical signal propagating toward a head end. An apparatus includes: an optical receiver; an optical divider coupled to the optical receiver; an optical diplexer coupled to the optical divider; an optical combiner coupled to the optical diplexer; and an optical transmitter coupled to the optical combiner.

### CROSS-REFERENCE(S) TO RELATED APPLICATION(S)

This application claims a benefit of priority under 35 U.S.C. 119(e) from copending provisional patent application U.S. Ser. No. 61/403,667, filed Sep. 20, 2010, the entire contents of which are hereby expressly incorporated herein by reference for all purposes.

### BACKGROUND INFORMATION

1. Field of the Invention

Embodiments of the invention relate generally to the field of networking. More particularly, an embodiment of the invention relates to radio frequency over glass customer premises equipment offering enhanced services overlay(s).

2. Discussion of the Related Art

Telephone companies such as Verizon and AT&T have started to offer services over fiber-to-the-premise (FTTP) and fiber-to-the-curb (FTTC) systems such as FiOS™ and U-Verse™. These systems offer dramatically higher reverse data bandwidths by bringing optical fiber to the home or close to home. Although HFC networks can deliver similar forward and reverse bandwidth, there are several capital intensive steps to achieve that goal due to legacy consumer electronics design. Moreover, in HFC networks with RF actives following the optical nodes, the RF actives need to be upgraded to provide more forward and reverse bandwidth. This is not needed in HFC networks with passive coaxial cable plant (also known as fiber deed or node+0 (N+0) HFC networks. Therefore, North American cable operators started deploying scalable fiber-to-the-home (FTTH) systems in green-field areas (especially areas with lower population density) or in the existing HFC areas, building upon fiber deployed to date, that can offer similar to, or higher than, bandwidths provided by FiOS™ and U-Verse™.

MSOs want to continue utilizing DOCSIS platform for wideband services such as high-speed data, Voice over IP (VoIP) and other services supported by this platform, which provides for downstream data bandwidth up to 640 Mb/s or more, until such a time as yet higher data speeds are required. At such a time, the MSOs want the flexibility to upgrade their FTTH CPE device to handle Gb/s data speeds offered by passive optical networks (PONs) such as GPON or GEPON. They also want to support deployed interactive TV services that are based on set top boxes with active upstream signaling to support fully interactive services such as Video on Demand (VoD) and Switched Digital Video (SDV).

RF over Glass (RFoG) is the name given to the generic FTTH architecture that supports both legacy DOCSIS cable upstream signals and an optional future expansion to additional high speed (>1 Gb/s) PON service. FIG. 1 shows the schematic diagram of a basic RFoG customer-premise-equipment (CPE) device used in RFoG system, also referred to as an R-ONU (for RF Optical Network Unit).

An example of the basic R-ONU shown in FIG. 1 is a low-cost device that provides only traditional cable services. This R-ONU device uses an optical filter to separate the downstream 1550 nm signal from the upstream 1610 nm signal. The upstream wavelength can be different and is used here as an example only. This filter is not deployed if two fibers are used, one for downstream and one for upstream. The R-ONU uses a 1610 nm laser for transmitting upstream signals and an optical receiver for detecting the downstream 1550 nm signal. The two paths are combined using a RF diplex filter onto the home coaxial cable. An optional “PON Upgrade Port” may be offered for compatibility with future PON upgrades.

### Bandwidth Limitations of Traditional RFoG

The problem with the traditional R-ONU shown in FIG. 1 is that both the forward and reverse paths are directly connected, via the L/H diplex filter, to the legacy cable in-building distribution network (the same as in any other HFC network today) to feed legacy consumer electronic equipment that has been designed for the frequency allocation for forward and reverse communications in traditional HFC and cable TV networks. Hence the forward and reverse bandwidths are severely constrained by the limitations of this legacy network. This bandwidth limitation is illustrated in FIG. 2 which shows the bandwidth utilization of the upstream and downstream wavelengths in a typical R-ONU. The upstream and downstream wavelengths may coexist on the same fiber if an optical filter is used, as in FIG. 1. Although the split frequency between downstream and upstream legacy band is different in different geographical areas, it is universal that upstream bandwidth is narrower with lower capacity and that the consumer electronics found today in households have been optimized for the local frequency split between upstream and downstream, including cost optimization, and are usually not compatible with other frequency splits unless the in-building network is upgraded at a significant expense (NCTA 2010 papers).

It can be seen that the upstream wavelength, in particular, is grossly underutilized because of the 5-42 MHz (5-65 MHz in Europe) limitation of cable's legacy return path network and legacy consumer electronic equipment and in-building distribution network. This limitation is due to the presence of analog channels starting at channel 2 (55.25 MHz) in the forward path. Consequently, there is only 37 MHz of usable return bandwidth (60 MHz in Europe). Cable companies have moved swiftly to roll out DOCSIS 3.0 cable modems which greatly increases upstream capacity compared with legacy cable modems.

The 37 MHz upstream bandwidth has a data capacity of more than 185 Mb/s since DOCSIS 3.0 (and DOCSIS 2.0) supports 64-QAM modulation which has an effective bit-rate efficiency of 5 bits/Hz. However, some frequency bands are set aside for 16-QAM modulation (for DOCSIS 1.1 legacy cable modems) and for QPSK modulation (for DOCSIS 1.0 legacy cable modems). Moreover, due to interference present at lower frequencies, some parts of the spectrum are not usable. The actual data capacity of a 6.4 MHz, 64-QAM channel is actually only 27 Mb/s (after accounting for guard-bands, the Nyquist rolloff parameter α, and the 10% FEC overhead). Similarly, the data capacity of a 3.2 MHz, 16-QAM channel is 9 Mb/s and that of a 3.2 MHz, QPSK channel is about 2 Mb/s.

A realistic fully-loaded reverse band in North America would thus include three to four 6.4 MHz, 64-QAM channels, possible with one 3.2 MHz, 16-QAM channel and one 3.2 MHz, QPSK channel. The total data capacity of this fully loaded reverse path is about 120 Mb/s.

The 120 Mb/s data capacity of a fully loaded 5-42 MHz reverse path in North America (and a corresponding bandwidth of over 210 Mb/s in Europe) was initially quite sufficient to meet customer expectations. Cable companies were able to roll out Fast Ethernet 100 Mb/s to residential and small-to-medium businesses (SMBs). However, competitive pressure now requires cable operators to start planning for symmetrical data capacity in the hundreds of Mb/s and Gb/s range.

Several techniques for increasing data capacity, especially in the reverse path, have been investigated for HFC networks.

1) Change cross-over point between the upstream and downstream bands in HFC networks.

The technique is to allocate more upstream spectrum by changing the cross-over points between the upstream and downstream bands. That is the upstream spectrum would be increased from the present 5-42 MHz band (in North America) to a wider band. Common options are 5-85 MHz (mid-split) and 5-200 MHz (high-split).

A major disadvantage of this technique is that reverse capacity is increased at the expense of downstream capacity. For example, a mid-split requires the removal of downstream channels 2-6 and channels 95-97. This is 54 MHz of downstream spectrum that is lost. The downstream capacity that is lost is higher than the upstream capacity that is gained since downstream signaling employs higher-order modulation such as 256-QAM rather than 16-QAM or 64-QAM.

Additionally, this approach would require either upgrading in-building networks to allow legacy consumer electronic un-impeded operation or replacement of these devices at significant cost per customer/household. In HFC networks with RF active devices pass the node, it would also require upgrading of these active devices or converting the HFC network to HFC network with passive coaxial plant.

2) Better spectral efficiency and more robust modulation in the existing 5-42 MHz band in HFC networks.

Modulation schemes such as OFDM (orthogonal frequency division multiple access) are being studied that provide higher spectral efficiency than offered by 64-QAM. Other modulation schemes that are more robust and can tolerate much lower SNR (signal to noise ratios) such as S-CDMA (synchronous code division multiple access) are also being investigated. The use of these more advanced modulation scheme can substantially increase the data capacity of the existing 5-42 MHz upstream band.

A major disadvantage of this technique is that much of the existing plant passives and actives, as well as set top boxes and CPE have to be replaced. Moreover, to drastically increase utilization of the reverse bandwidth with much higher modulation levels would also require significant improvements in the performance of the reverse plant, even if more robust coding techniques are used to take advantage of the upstream spectrum with higher interference levels. The capacity gains diminish with higher modulation schemes while requirements for performance improvement rise exponentially.

3) Increase upstream capacity by using spectrum above 1 GHz in HFC networks.

In this scheme, part of the unused spectrum above 1 GHz is used for upstream signaling. Trunk cable as well as drop cable can support frequencies in the 1-3 GHz band, although the RF attenuation can become very high above 2 GHz.

A major disadvantage of this scheme is that fiber nodes and other actives (amplifiers) and plant passives (directional couplers, splitters and taps) will need to be modified to support the use of the spectrum above 1 GHz. Modifications to plant actives may be minimal in fiber deep architectures but modifications to plant passives cannot be avoided.

In RFoG FTTH networks, the following ways of increased downstream and upstream capacity have been investigated.

4) Provide Gb/s data capacity by a 1G(E)PON and 10G(E)PON overlay in RFoG FTTH deployments.

In this technique, the R-ONU is modified to provide support for 1G(E)PON and 10G(E)PON.

The 1G(E)PON-compatible R-ONU shown in FIG. 3 would be used to provide both traditional cable services and G(E)PON service to residences and small-to-medium businesses (SMBs). An additional optical filter has been added to provide two additional wavelengths for supporting 1G(E)PON—namely 1310 nm (upstream) and 1490 nm(downstream).

The situation becomes complicated with the standardization (in 2010) of 10G(E)PON which uses an upstream wavelength of 1270 nm (±10 nm) and a downstream wavelength of 1577 nm (+3 nm,−2 nm). Cable operators who had deployed 1G(E)-compatible R-PONs would come under pressure to support 10G(E)PON service while maintaining compatibility with the previous 1G(E)PON service.

FIG. 4 shows an R-ONU which represents 1G(E)PON-compatible R-ONU that has been upgraded to 10G(E)PON service by the addition of more optical filters and a 10G (E) Optical Network Unit (ONU).

The addition of the 1270 nm and 1577 nm filters add substantially to the cost of the 10G(E)-compatible R-ONU, especially due to the narrow wavelength separation between the downstream cable service (1550 nm±20 nm over temperature) and the downstream 10G(E)PON service (1577 nm+3 nm,−2 nm). The wavelength separation between the downstream cable service and the downstream 10G(E)PON service could be as small as 5-10 nm if the effects of temperature variations are taken into consideration. As a result of this very small guard-band, design of the 1577 nm filter will prove to be technically challenging and this will be reflected in the price of this filter. Moreover, as seen in FIGS. 3 and 4, the number of transmitters and receivers in the ONU increases thus increasing its cost on a per customer basis.

### SUMMARY OF THE INVENTION

There is a need for the following embodiments of the invention. Of course, the invention is not limited to these embodiments.

According to an embodiment of the invention, a method comprises: receiving a downstream optical signal propagating away from a head end; splitting the downstream optical signal into a downstream high portion and a downstream low portion; diplexing the downstream low portion with an upstream low portion; combining the upstream low portion and an upstream high portion; and transmitting the combined upstream portions as an upstream optical signal propagating toward a head end. According to another embodiment of the invention, a method comprises: receiving a downstream optical signal propagating away from a head end; diplexing the downstream optical signal into a downstream high portion and a downstream low portion; diplexing the downstream low portion with an upstream low portion; combining the upstream low portion and an upstream high portion; and transmitting the combined upstream portions as an upstream optical signal propagating toward a head end.

According to another embodiment of the invention, an apparatus comprises: an optical receiver; an optical splitter coupled to the optical receiver; an optical diplexer coupled to the optical splitter; an optical combiner coupled to the optical diplexer; and an optical transmitter coupled to the optical combiner. According to another embodiment of the invention, an apparatus comprises: an optical receiver; a first optical diplexer coupled to the optical receiver; a second optical diplexer coupled to the first optical diplexer; an optical combiner coupled to the second optical diplexer, wherein a low port of the first optical diplexer is coupled to a high port of the second optical diplexer and a low port of the second optical diplexer is coupled to a low input of the optical combiner; a down convertor coupled to the high port of the first optical diplexer; a baseband device coupled to the down convertor; an up converter coupled between the baseband device and a high input of the optical combiner; and an optical transmitter coupled to the optical combiner.

These, and other, embodiments of the invention will be better appreciated and understood when considered in conjunction with the following description and the accompanying drawings. It should be understood, however, that the following description, while indicating various embodiments of the invention and numerous specific details thereof, is given for the purpose of illustration and does not imply limitation. Many substitutions, modifications, additions and/or rearrangements may be made within the scope of an embodiment of the invention without departing from the spirit thereof, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer concept of embodiments of the invention, and of components combinable with embodiments of the invention, and operation of systems provided with embodiments of the invention, will be readily apparent by referring to the exemplary, and therefore nonlimiting, embodiments illustrated in the drawings (wherein identical reference numerals (if they occur in more than one view) designate the same elements). Embodiments of the invention may be better understood by reference to one or more of these drawings in combination with the following description presented herein. It should be noted that the features illustrated in the drawings are not necessarily drawn to scale.

FIG. 1 is a schematic diagram of a basic R-ONU that provides only traditional cable services (using 1550 nm down/1610 nm up wavelengths) and no PON (although an optional PON upgrade port may be available as shown).

FIGS. 2A-2B are diagrams of bandwidth utilization of the upstream and downstream wavelengths in a typical R-ONU.

FIG. 3 is a schematic diagram of an R-ONU that provides both traditional cable services (using 1550 nm down/1610 nm up wavelengths) and 1G(E)PON service (using 1490 nm down/1310 nm up wavelengths).

FIG. 4 is a schematic diagram of a 10G(E)-compatible R-ONU that provides traditional cable services (using 1550 nm down/1610 nm up wavelengths), 1G(E)PON service (using 1490 nm down/1310 nm up wavelengths) and 10G(E)PON service (using 1577 nm down/1270 nm up wavelengths).

FIG. 5 is a schematic diagram of an R-ONU that provides full-bandwidth upstream and/or downstream paths.

FIGS. 6A-6B are RF spectra of upstream and downstream fibers, showing generic upstream and downstream frequency allocations.

FIG. 7 is a schematic diagram of an embodiment of an R-ONU that provides a bi-directional port for legacy cable services and an additional pair of uni-directional ports for new services.

FIG. 8 is a schematic diagram of an embodiment of an R-ONU that provides a bi-directional port for legacy cable services and another bi-directional port for enhanced services.

FIG. 9 is a schematic diagram of an embodiment of proposed R-ONU with generic frequency plans.

FIGS. 10A-10B are RF spectra of upstream and downstream fibers, showing legacy and enhanced frequency allocations.

FIG. 11 is a schematic diagram of an embodiment of R-ONU with that incorporates a Hi-PHY modem; the up-converter takes the baseband output of the Hi-PHY modem and up-converts it into the frequency band f₂-f₃ MHz; this is then combined with the 5-f₁ MHz cable return band and the combined 5-f₃ MHz composite signal drives the upstream laser transmitter.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The invention can include an R-ONU that offers enhanced capacity in both the downstream and upstream paths (in the multi Gb/s range) that is not cost-effectively achievable in HFC networks, especially those with RF actives past the optical node. This is done without requiring modifications to in-building signal distribution networks and without reducing the data capacity of the downstream path (as in the mid-split or high-split techniques described above) while preserving compatibility of the legacy consumer electronics equipment with the new bandwidth and capacity allocation. The proposed device can provide multi Gb/s symmetrical capacity without the need for a PON overlay—but if so desired, PON can be supported without the need for additional optical filters by using a baseband modem in one of the embodiments of this invention.

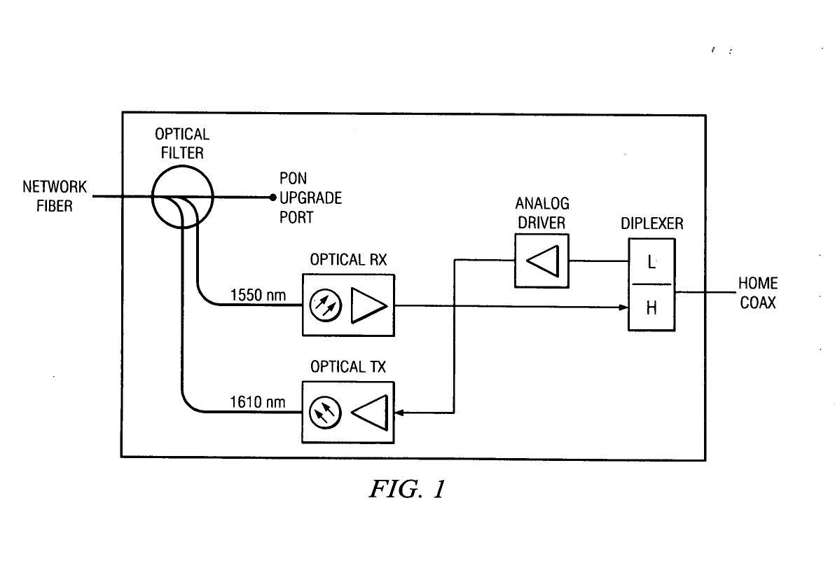

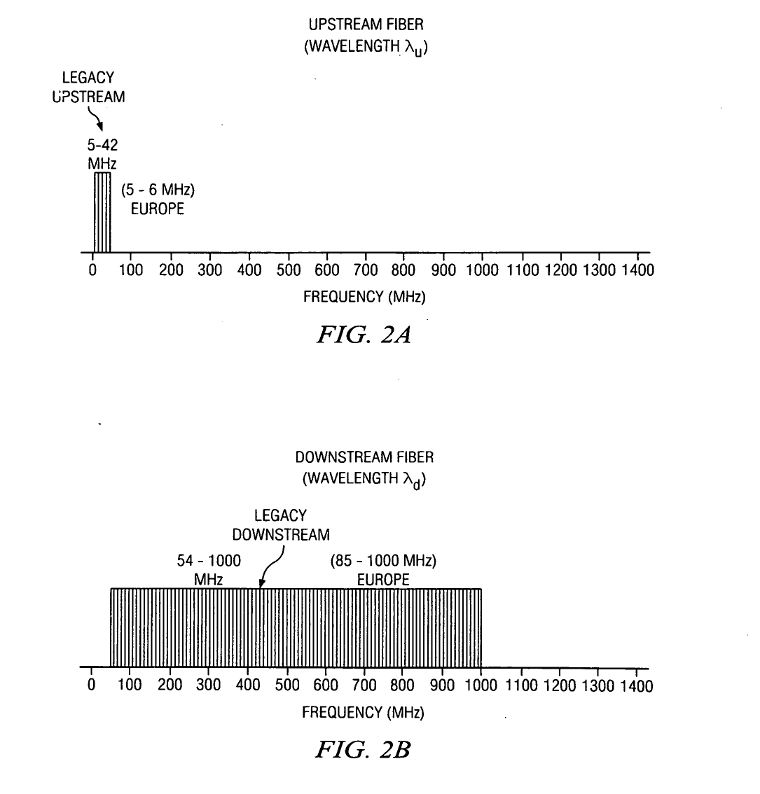

The main deficiency of traditional R-ONUs (FIG. 1) is that, although there are two wavelengths present (for upstream and downstream signal transport), the R-ONU does not utilize it to make full use of the spectrum available. This was shown in FIG. 2 which illustrated that (in North America) the upstream fiber is limited to the frequency band 5-42 MHz and the downstream fiber is limited to the frequency band 54-1000 GHz. The upstream spectrum cannot be increased above 42 MHz because legacy CEs would not be compatible with this wider upstream band. The downstream spectrum cannot be increased above 1000 MHz because of the presence of MoCA (Multimedia Over Coax Alliance) signals in the 1100-1200 MHz band.

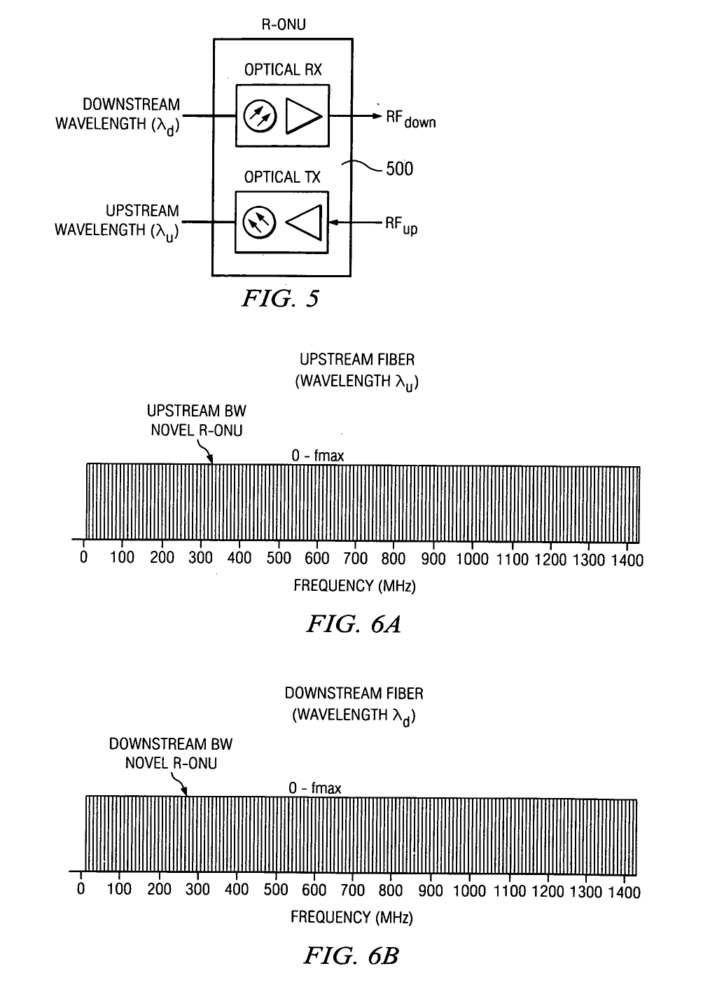

The invention can include an R-ONU 500 that overcomes these limitations and provides full-bandwidth upstream and downstream paths. The most generic embodiment of the proposed invention is shown in the schematic diagram of FIG. 5.

The upstream signal, RFᵤₚ, and the downstream signal, RF_{down}, are both full-bandwidth signals in the frequency band 0-fₘₐₓ (where fₘₐₓ is in the multi GHz range) as shown in FIG. 6. FIG. 6 illustrates the point that the proposed device does not have the constraint (of traditional R-ONUs) that the upstream and downstream frequency bands not overlap.

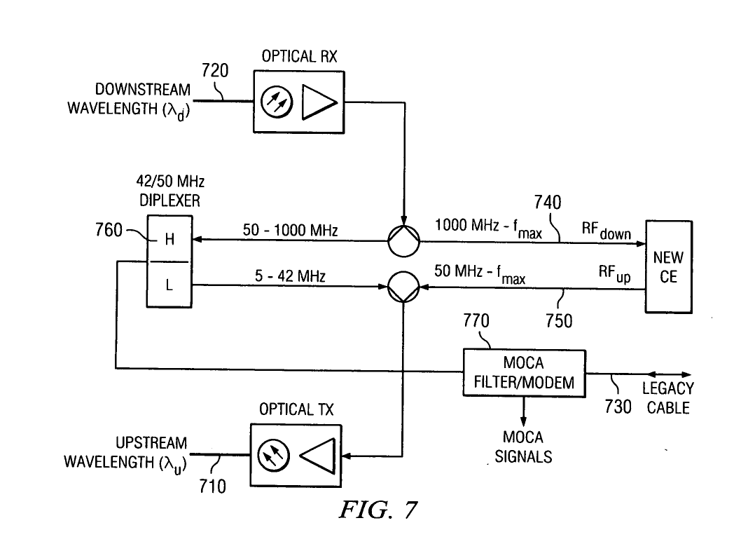

Another, embodiment of an R-ONU is shown in FIG. 7. The R-ONU is shown as a two-fiber device, with an upstream fiber 710 utilizing wavelength λᵤ and a downstream fiber 720 utilizing wavelength λ_{d}. The two wavelengths could be equal if desired. If the two wavelengths are not equal then a simple optical mux/dmux combiner could be used to combine them over a single fiber if desired.

The device has one bi-directional RF input/output 730 for legacy cable service, and also provides two uni-directional RF ports 740, 750 for use with future CE devices such as cable modems, set top boxes, Hi-PHY (advanced modulation modems), etc. The “legacy cable” port 730 is connected to existing cable equipment such as set-top-boxes and cable modems.

In this typical North American example, the legacy cable service includes an upstream frequency band 5-42 MHz and a downstream frequency band 50-1000 MHz. This is for example only, and this description applies to a mid-split, high-split, or any other frequency plan.

The two new ports provided, labeled RF_{down} and RFᵤₚ, utilize the upstream frequency band 50-fmax and the downstream frequency band 1000-fmax in this example. However, the lower boundary of the forward bandwidth on this port can be as low as practically possible (e.g., 5 MHz). The H/L diplex filter 760 shown in FIG. 7 ensures that the 5-42 MHz upstream band and the 50-1000 MHz downstream band are connected to the “legacy cable” port and the rest of the spectrum goes to the “new CE” ports. In this fashion, both the upstream and downstream wavelengths use the full spectrum from 0 to fₘₐₓ.

The MOCA filter/modem 770 in the legacy cable path extracts the MOCA signaling (typically in the 1100-1200 MHz band) and can be used to control the CPE for use as a standalone device or as part of a gateway. MOCA is used as an example here—the description applies to other types of in-house signaling also.

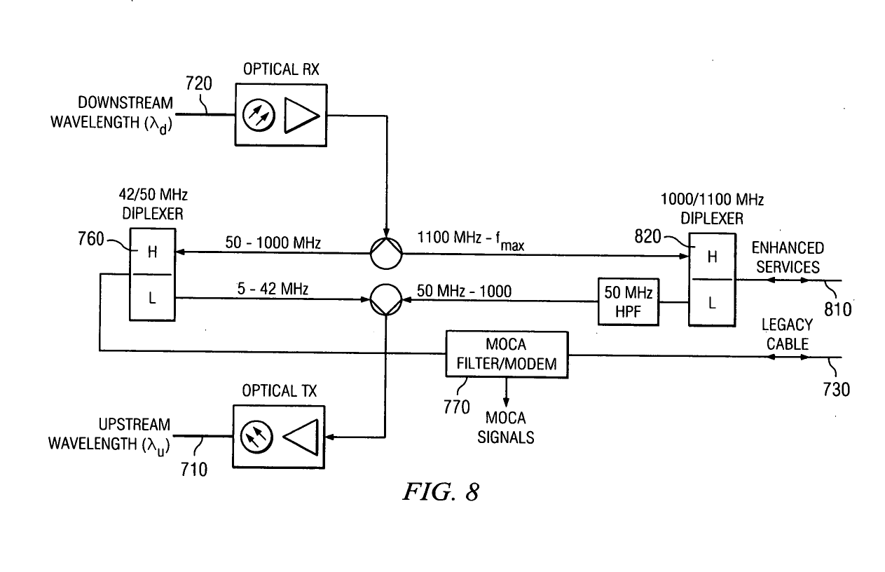

Another embodiment of the invention is shown in FIG. 8. It is similar to the previous embodiment except that the pair of uni-directional ports connected to the “New CE” has been replaced by a single bi-directional cable 810 that can be connected to a future CE to offer enhanced services. The bi-directional operation is made possible by a new diplexer 820, namely the 1000/1100 MHz diplexer shown in this example. The 50 MHz HPF (high pass filter) is used to make sure that there are no frequency components in the upstream enhanced services path that can interfere with the 5-42 MHz upstream cable path.

It is assumed in this example that the future CE utilizes an upstream frequency band from 10-1000 MHz and a downstream frequency band from 1100 MHz to fₘₐₓ. The cross-over frequencies (1000 MHz and 1100 MHz) are an example only. The description applies to any other cross-over frequencies.

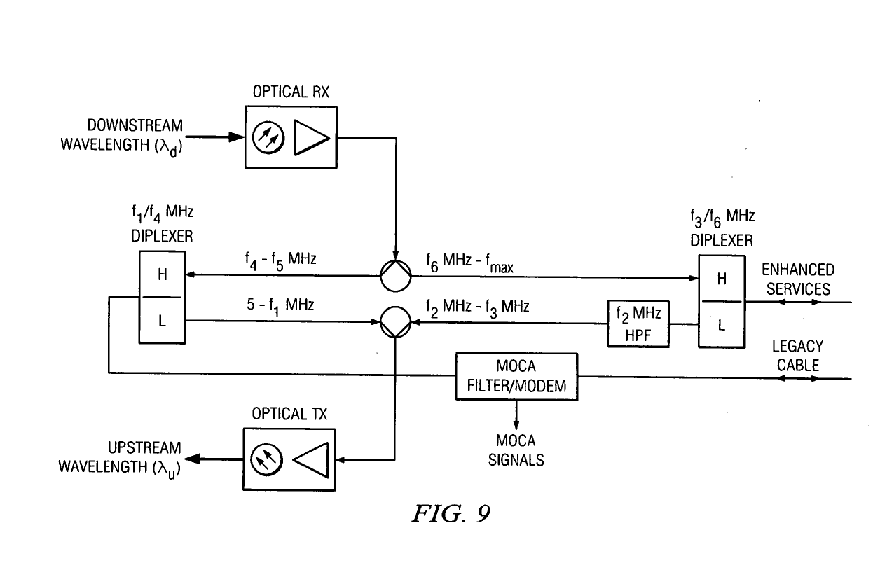

A generic form of the previous embodiment is shown in FIG. 9. The frequency plans used by the legacy cable services and the enhanced services have been made variables for broader applicability.

The diplexers associated with the “existing services” and “enhanced services” are now f₁/f₂ MHz and f₃/f₆ MHz, respectively. The high-pass filter in the upstream path of the “enhanced services” now has a generic threshold frequency of f₂ MHz. The legacy cable service is assumed to lie in the frequency bands 5-f₁ MHz (upstream) and f₄-f₅ MHz (downstream). The enhanced service is assumed to lie in the frequency bands f₂-f₃ MHz (upstream) and f₆-fₘₐₓ (downstream) as shown in FIG. 8. These frequencies should satisfy the conditions 5 MHz<f₁<f₂<f₃<f₆ and f₁<f₄<f₅<f₆<fₘₐₓ.

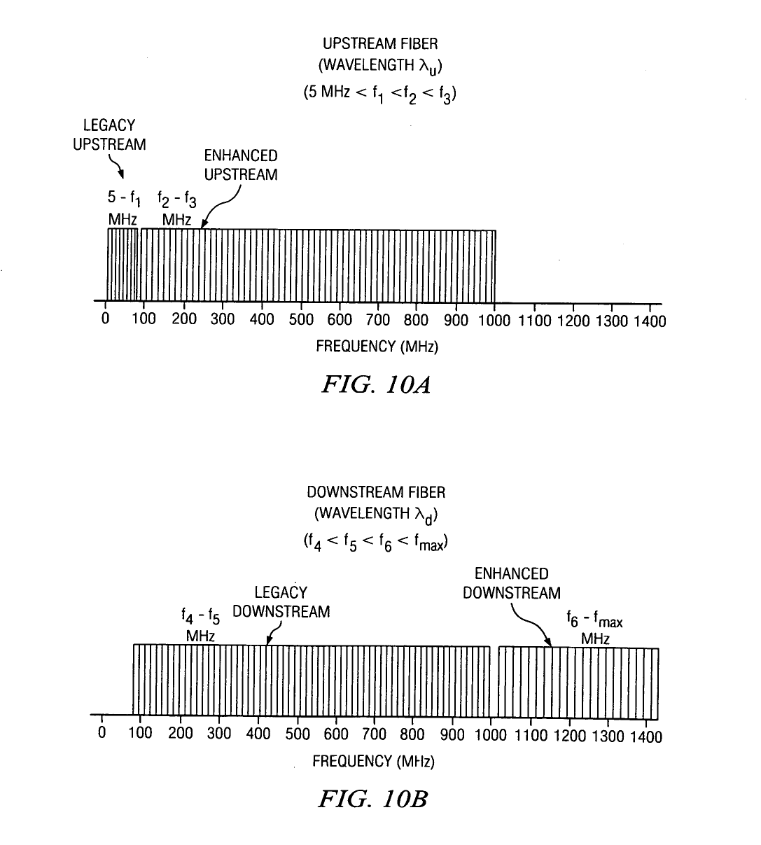

The frequency bands used by the legacy cable and the enhanced services are shown in FIG. 10. In the upstream paths, the RF diplexer in the “legacy cable” path extracts the frequency band 5-f₁ MHz while the RF diplexer in the “enhanced services” path extracts frequencies below f₃ MHz; these signals come out of the “L” ports of the two diplexers. The signal from the “enhanced services” diplexer is then filtered using a f₂ MHz high-pass filter, resulting in a f₂-f₃ MHz upstream signal that is then combined with the 5-f₁ MHz legacy cable upstream. This combined 5-f₃ MHz composite signal then drives the upstream laser transmitter.

In the downstream path, the optical receiver output is fed to a splitter and the two outputs of this splitter is fed to the “H” ports of the two RF diplexers. The result is that the frequency band f₄-f₅ MHz comes out of the “legacy cable” output while the frequency band f₆-fₘₐₓ comes out of the “enhanced services” output, as desired. In this manner, overlay of the enhanced services using frequency band above those of the existing legacy cable services has been performed in a very inexpensive manner using only RF filters, diplexers and splitter/combiners.

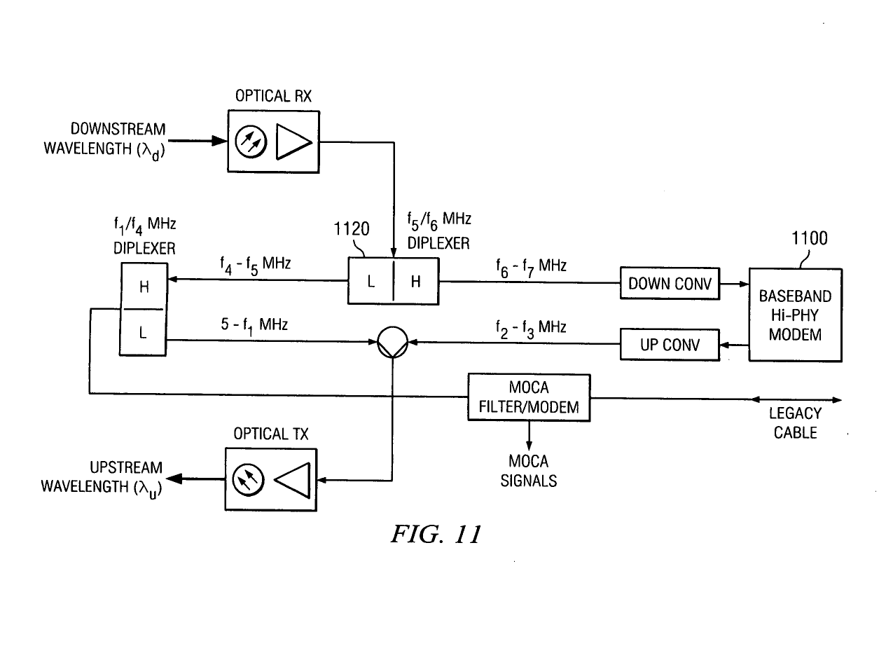

The CE device shown in FIG. 7 cannot be a baseband modem since neither RFᵤₚ or RF_{down} includes frequencies down to 0 Hz. However, by converting one of the RF splitters into a diplexer filter and adding up- and down-converters, an embodiment of the invention can support a baseband Hi-PHY modem 1100 as shown in FIG. 11.

The downstream f₅/f₆ diplexer 1120 is used to separates the cable downstream (in the frequency band f₄-f₅ MHz) from the Hi-PHY downstream (in the frequency band f₆-f₇ MHz). The frequency band f₆-f₇ MHz is then down-converted to baseband frequencies so that the Hi-PHY modem input sees a baseband signal. These frequencies should satisfy the conditions 5 MHz<f₁<f₂<f₃ and 5 MHz<f₁<f₄<f₅<f₆<f₇.

The Hi-PHY modem 1100 can be proprietary or non-proprietary and could be of any modulation type. Although the term Hi-PHY usually denotes advanced modulation techniques with high bit-rate efficiencies, standard modulation techniques are not ruled out. They could, for example, be modems that provide G(E)PON services.

In summary, a novel RFoG R-ONU device has been described that can utilize the full spectrum of both the upstream and downstream wavelengths of an RFoG system, thereby offering data capacity up to multiple Gb/s using simple RF filters and splitters rather than a complex mix of expensive optical filters and additional wavelengths that is currently employed in an effort to provide higher data capacities. Some embodiments of the proposed R-ONU are compatible with existing CEs as well as Hi-PHY modems (standard or proprietary) and are also compatible with in-home signaling schemes including, but not limited to, MoCA.

This novel R-PON can be used over long distances from the headend using Aurora's VHub technology that uses optical amplifiers for the downstream 1550 nm signal and optical receivers that use multiple photodiodes in a novel combining network to provide very low effective thermal noise properties with digital links in the upstream path from the VHub.

In a first embodiment, the invention can include an R-ONU device that in its broadest embodiment includes an optical receiver for detecting a downstream wavelength and a laser transmitter for transmitting over an upstream wavelength (that may be the same as the downstream wavelength) as shown in FIG. 5. This provides two RF ports, one for the downstream signals and one for the upstream signals, and the full RF spectrum (from 0 Hz to multi-GHz) is utilized in both the downstream and upstream wavelengths. This is in contrast to traditional R-ONUs that utilize only the cable return band (5-42 MHz in North America or 5-65 MHz in Europe) on the upstream wavelength.

In a second embodiment, the invention can include an R-ONU that adds an RF diplex filter and provides three ports: one for bi-directional legacy cable services and two uni-directional ports (for upstream and downstream signaling) that can be used with future CE devices such as cable modems, set top boxes and RF Hi-PHY modems. This is shown in FIG. 7. RF filters are provided to provide compatibility with in-home signaling including (but not limited to) MoCA.

In a third embodiment, the invention can include an R-ONU that adds one more RF diplex filter and hence provides two bi-directional RF ports: one for legacy cable and another for enhanced services. This is shown in FIG. 8. The enhanced services port allows cable providers to provide multi-Gb/s data services without adding more wavelengths making this technique a very low-cost means of increasing data capacity, especially in the return path that is the bottleneck in traditional RFoG systems.

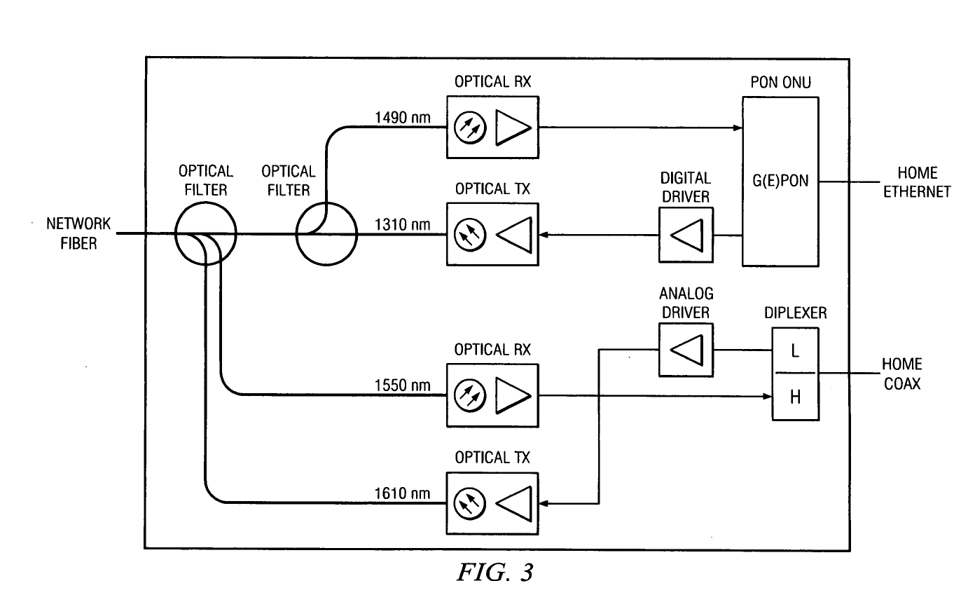

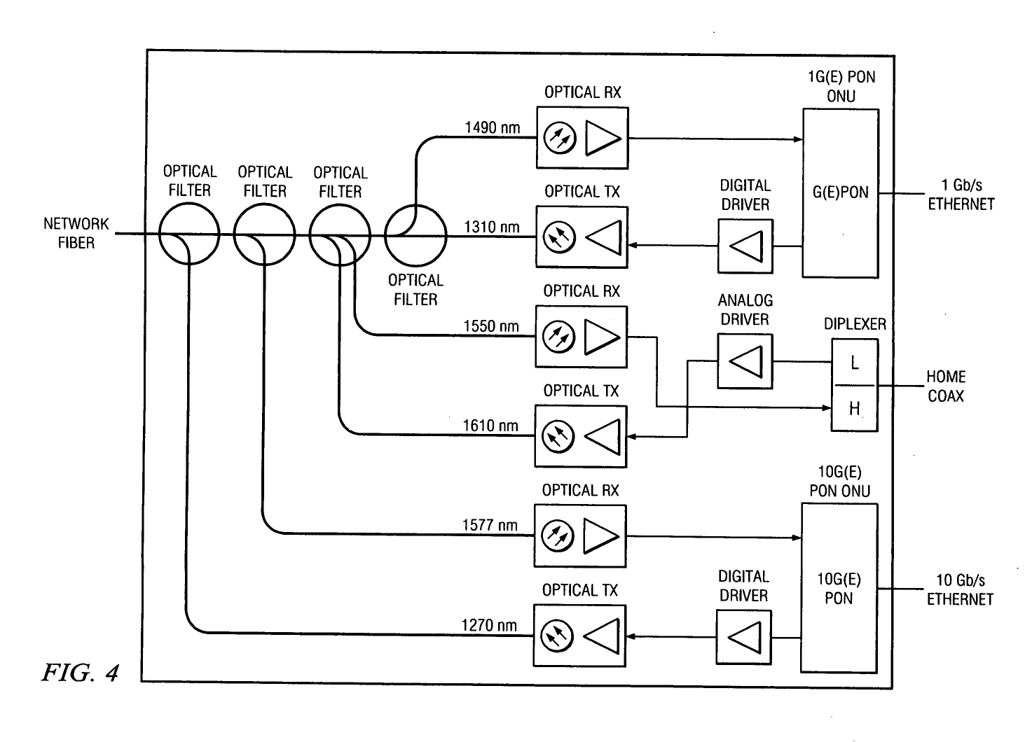

In a fourth embodiment, the invention can include an R-ONU that adds RF up-converters and down-converters so that a baseband Hi-PHY modem can be used as shown in FIG. 11. The Hi-PHY modem can be proprietary or non-proprietary and could be of any modulation type. PON services such as G(E)PON can be provided using such baseband modems. This is a major advantage over traditional R-ONUs that require additional upstream and downstream wavelengths in order to provide PON service, as shown in FIGS. 3 and 4.

### CONCLUSION

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences.

Various substitutions, modifications, additions and/or rearrangements of the features of embodiments of the invention may be made without deviating from the spirit and/or scope of the underlying inventive concept. All the disclosed elements and features of each disclosed embodiment can be combined with, or substituted for, the disclosed elements and features of every other disclosed embodiment except where such elements or features are mutually exclusive. The spirit and/or scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
receiving a downstream optical signal propagating away from a head end;
splitting the downstream optical signal into a downstream high portion and a downstream low portion;
diplexing the downstream low portion with an upstream low portion;
combining the upstream low portion and an upstream high portion; and
transmitting the combined upstream portions as an upstream optical signal propagating toward a head end.

2. The method of claim 1, wherein the downstream high portion is conveyed to a device and the upstream high portion is conveyed from the device.

3. The method of claim 1, further comprising diplexing the downstream high portion and the upstream high portion and filtering the upstream high portion.

4. The method of claim 1, further comprising filtering a portion of the diplexed downstream low portion and filtering a portion of the upstream low portion.

5. The method of claim 4, further comprising decoding the filtered diplexed downstream low portion and encoding the filtered diplexed upstream low portion.

6. A method, comprising:
receiving a downstream optical signal propagating away from a head end;
diplexing the downstream optical signal into a downstream high portion and a downstream low portion;
diplexing the downstream low portion with an upstream low portion;
combining the upstream low portion and an upstream high portion; and
transmitting the combined upstream portions as an upstream optical signal propagating toward a head end.

7. The method of claim 6, further comprising downconverting the diplexed downstream high portion and upconverting the diplexed upstream high portion.

8. The method of claim 6, further comprising conveying the downconverted, diplexed downstream high portion to a baseband device and conveying the upconverted, diplexed upstream high portion from the baseband device.

9. The method of claim 6, further comprising filtering a portion of the diplexed downstream low portion and filtering a portion of the upstream low portion.

10. The method of claim 9, further comprising decoding the filtered diplexed downstream low portion and encoding the filtered diplexed upstream low portion.

11. An apparatus, comprising:
an optical receiver;
an optical splitter coupled to the optical receiver;
an optical diplexer coupled to the optical splitter;
an optical combiner coupled to the optical diplexer; and
an optical transmitter coupled to the optical combiner.

12. The apparatus of claim 11, wherein a low output of the optical splitter is coupled to a high port of the optical diplexer and a low port of the optical diplexer is coupled to a low input of the optical combiner.

13. The apparatus of claim 12, further comprising a device coupled to both a high output of the optical splitter and a high input of the optical combiner.

14. The apparatus of claim 12, further comprising another optical diplexer coupled to both the optical splitter and the optical combiner, wherein a high port of the another optical diplexer is coupled to a high output of the optical splitter and a low port of the another optical diplexer is coupled to a high input of the optical combiner.

15. The apparatus of claim 14, further comprising a high pass filter coupled between the low port of the another optical diplexer and the high input of the optical combiner.

16. The apparatus of claim 11, further comprising a filter/modem coupled to a common port of the optical diplexer.

17. A network, comprising the apparatus of claim 11.

18. An apparatus, comprising:
an optical receiver;
a first optical diplexer coupled to the optical receiver;
a second optical diplexer coupled to the first optical diplexer;
an optical combiner coupled to the second optical diplexer, wherein a low port of the first optical diplexer is coupled to a high port of the second optical diplexer and a low port of the second optical diplexer is coupled to a low input of the optical combiner;
a down convertor coupled to the high port of the first optical diplexer;
a baseband device coupled to the down convertor;
an up converter coupled between the baseband device and a high input of the optical combiner; and
an optical transmitter coupled to the optical combiner.

19. The apparatus of claim 18, further comprising a filter/modem coupled to a common port of the second optical diplexer.

20. A network, comprising the apparatus of claim 18.
